(19) United States
(12) Patent Application Publication
(10) Pub. No.: US 2006/0277139 A1
(43) Pub. Date: Dec. 7, 2006

(54) System and method for credit account management

(76) Inventor: Alexander I. Poltorak, Monsey, NY (US)

Correspondence Address: ANATOLY S. WEISER, 3525 DEL MAR HEIGHTS ROAD, #295, SAN DIEGO, CA, 92130, US

(21) Appl. No.: 11/146,405

(22) Filed: Jun. 6, 2005

(51) Int. Cl. G06Q 40/00

(52) U.S. Cl. 705/38

(57) ABSTRACT

A computer-based system and method obtain information regarding a customer's credit accounts and income, and an authorization to receive the customer's credit report. The customer's financial profile, including statements of the credit accounts and credit reports, are periodically reviewed by the system to determine whether better credit terms are likely to be available to the customer. If better terms are likely to be available, the system automatically applies for credit on behalf of the customer, receives approvals, and transfers balances from existing accounts to new accounts with better terms. The system may automatically obtain account information regarding the customer's credit accounts via a network, and schedule and make payments on the accounts in accordance with the information obtained and parameters prescribed by the customer. When each payment is made, a statement is sent, advising the customer of total interest charges and length of the repayment period under various assumptions.

### FIELD OF THE INVENTION

The present invention relates generally to management of credit accounts. More particularly, the present invention relates to apparatus, systems, and articles of manufacture for enabling credit users to control cost of credit.

### BACKGROUND

Credit accounts have become an important part of financial life for many people. A typical consumer has several credit cards. More important, many consumers carry credit balances on one or more credit cards and other credit accounts. The costs of carrying a credit balance vary widely from person to person and from time to time. Furthermore, credit costs may vary widely for the same person and at the same time, depending on the terms of the particular account used.

Those with relatively good credit ratings often receive teaser rate offers to transfer balances or otherwise to borrow money from a lender. A teaser rate is a below market rate. Teaser rates, which range down to zero percent, are typically offered for an introductory period of a limited time duration. Unfortunately, credit card companies and other consumer lenders often attempt to make exorbitant profits when the introductory period for the teaser rate expires, or upon occurrence of a number of predetermined events that allow the rate for a particular customer to be raised. For example, the interest rate may be raised to the maximum allowed by law when the customer makes a periodic payment that is late by even a single day. Even worse, the interest rate may go up to the maximum allowed by law if the customer makes a late payment to any other creditor.

It may be possible for a consumer-borrower with a good credit rating to rotate an outstanding credit balance from one lender to another, using multiple teaser rate offers. This process, however, is time consuming, requiring the borrower to monitor the terms of various credit offers and to rotate balances from one credit account to another credit account in a timely manner. Thus, even consumers who avoid contractual traps that allow interest rate to be raised during the introductory period, may end up paying market and above market interest rates after the expiration of the introductory period.

Furthermore, quite often consumers are not aware of the actual interest rates charged on their outstanding balances. Even those consumers who know what interest rate is being applied, may not be aware of the length of the repayment period if only a minimum required payment is made to the credit account. Consumers also may not have an idea of the total amount of interest that will be paid when making only the minimum required payments.

It would be desirable to facilitate the process of taking advantage of various low interest rate borrowing opportunities, and otherwise to minimize costs of credit. It would also be desirable to keep borrowers better informed regarding borrowing terms and costs.

### SUMMARY

A need thus exists to help consumers to lower the cost of credit, for example, by taking advantage of low cost credit offers, such as offers with zero rate interest. A need also exists to help consumers to be better informed regarding lengths of repayment periods and total borrowing costs.

Embodiments of the present invention are directed to methods, apparatus, and articles of manufacture that satisfy one or more of these needs. In some embodiments, the invention herein disclosed is a computer-implemented method of managing credit. In accordance with the method, a computer system, such as an Internet portal, receives from a customer authorization to act on behalf of the customer to make applications for new credit accounts and to accept credit offers directed to the customer. The system applies for one or more new credit accounts on behalf of the customer, and, in response, receives approval of at least one new credit account of the customer with financial terms better than financial terms of at least one current credit account of the customer. The system then opens the at least one new credit account on behalf of the customer, and transfers at least a portion of credit balance from the at least one current credit account to the at least one new credit account.

In selected aspects, the system also receives from the customer credit account information with data regarding the at least one current credit account. The credit account information is used to obtain financial terms of the at least one current credit account. The financial terms of the at least one new credit account are compared to the financial terms of the at least one current credit account before the at least one new credit account is opened.

In selected aspects, a next time for performing the step of applying is scheduled after the balance is transferred. The next time may be scheduled, for example, one billing cycle of the at least one new credit account after balance transfer is completed. Thus, if the billing cycle is one month, the next time for applying may be scheduled one month after the transfer of the balance from the current credit account to the new credit account is completed.

In selected aspects, the credit account information received from the customer includes the customer's user name and password for logging onto a web site that provides information about the at least one current credit account. The user name and the password are used by the system to log onto the web site and obtain from the web site account statement of the at least one current credit account. The financial terms of the at least one current credit account are then determined from the statement.

In selected aspects, the financial terms of the at least one current credit account include interest rate applied to the customer's balance in the at least one current credit account. Comparing the financial terms includes performing a comparison of the interest rate applied to the balance in the at least one current credit account to interest rate associated with the at least one new credit account.

In selected aspects, the at least one new credit account is opened in response to the comparison between the financial terms resulting in a determination that the interest rate applied to the balance in the at least one current credit account is higher than the interest rate associated with the at least one new credit account.

In selected aspects, the method also includes registering the customer over the Internet. Registration is performed before the system receives authorization from the customer, applies for one or more new credit accounts, receives approval, opens the at least one new credit account, or transfers balance to the at least one new credit account. Registration may include obtaining the customer's contact information and displaying to the customer disclaimers, disclosures, and terms of agreement between the customer and operator of the system that performs the method.

In some embodiments, the invention herein disclosed is a computer implemented method of helping a customer to manage credit accounts. In accordance with this method, a computer system, such as an Internet portal, obtains from the customer information regarding a plurality of credit accounts of the customer. The information regarding the credit accounts is sufficient to log onto web site of each credit account of the plurality of credit accounts and obtain a statement of the customer's credit account associated with the web site. The system also obtains from the customer information regarding an electronic payment account from which the customer can make electronic (on line) bill payments. The information regarding the electronic payment account is sufficient to log onto a web site of the electronic payment account and make bill payments from the electronic payment account. The system logs onto the web site of each credit account and obtains statement of the credit account. Based on the statements, the system schedules payment dates and payment amounts for each credit account. The system also generates a report for each credit account, wherein the report includes an estimate of repayment period length computed assuming that only minimum payments are made to the corresponding credit account. The system then causes payments to be made to each credit account from the electronic payment account on the scheduled dates and in the amounts that have been previously determined. The reports corresponding to the credit accounts are sent to the customer as the payments are made.

In selected aspects, the steps of obtaining information regarding the plurality of credit accounts, obtaining information regarding the electronic payment account, logging onto the web site of each credit account, causing payments to be made, and sending reports are performed over the Internet.

In selected aspects, the estimate of repayment period length is based on an assumption that interest rate will remain constant.

In selected aspects, the estimate of repayment period length is based on an assumption that interest rate will vary in accordance with an economic forecast.

In selected aspects, each report further includes an estimate of total interest paid to the corresponding account during the repayment period.

In selected aspects, the report further includes an estimate of a second repayment period length computed assuming that each payment made to the corresponding credit account includes a predetermined amount in excess of a minimum payment amount.

In selected aspects, the report further includes an estimate of total interest paid to the corresponding credit account computed assuming that each payment made to the credit account includes a predetermined amount in excess of a minimum payment amount.

These and other features and aspects of the present invention will be better understood with reference to the following description, drawings, and appended claims.

### BRIEF DESCRIPTION OF THE FIGURES

FIG. 1 illustrates selected components of a computer-based system configured to perform credit management steps of a method in accordance with an embodiment of the present invention;

FIG. 2 illustrates selected steps of a method for managing credit accounts, in accordance with an embodiment of the present invention;

FIG. 3 illustrates selected steps of another method for managing credit accounts, in accordance with an embodiment of the present invention; and

FIG. 4 illustrates selected steps of a process for making payments to credit accounts, in accordance with an embodiment of the present invention.

### DETAILED DESCRIPTION

In this document, the words “embodiment” and “variant” refer to particular apparatus, process, or article of manufacture, and not necessarily to the same apparatus, process, or article of manufacture. Thus, “one embodiment” (or a similar expression) used in one place or context can refer to a particular apparatus, process, or article of manufacture; the same or a similar expression in a different place can refer to a different apparatus, process, or article of manufacture. The expression “alternative embodiment” and similar expressions and phrases are used to indicate one of a number of different possible embodiments. The number of possible embodiments is not necessarily limited to two or any other quantity. Characterization of an item as “exemplary” means that the item is used as an example. Such characterization of an embodiment does not necessarily mean that the embodiment is a preferred embodiment; the embodiment may but need not be a currently preferred embodiment. All embodiments are described for illustration purposes and are not strictly limiting.

The words “couple,” “connect,” and similar expressions with their inflectional morphemes do not necessarily import an immediate or direct connection, but include connections through mediate elements within their meaning.

Other and further definitions and clarifications of definitions may be found throughout this document.

Reference will now be made in detail to several embodiments of the invention that are illustrated in the accompanying drawings. Same reference numerals are used in the drawings and the description to refer to the same apparatus elements and method steps. The drawings are in simplified form, not to scale, and omit apparatus elements and method steps that can be added to the described systems and methods, while including certain optional elements and steps.

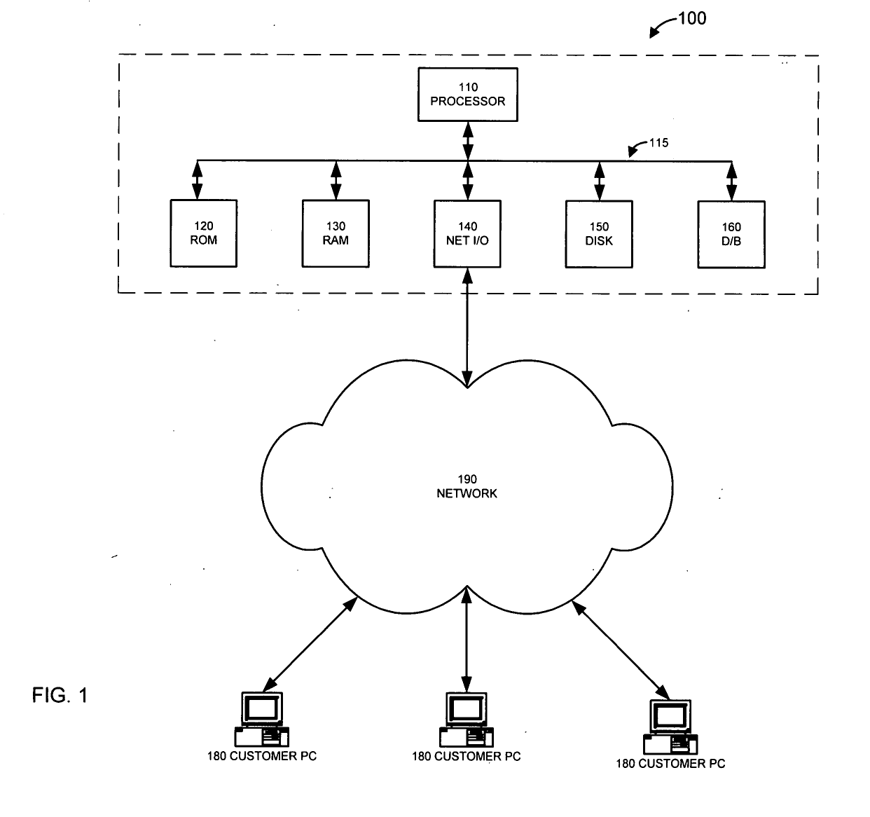

FIG. 1 is a simplified block diagram representation of a computer-based system 100 configured in accordance with selected aspects of the present invention. As shown in FIG. 1, the system 100 is coupled to customer computers 180 via a communication network 190. FIG. 1 does not show many hardware and software modules of the system 100, and omits several physical and logical connections. The system 100 can be implemented as a special purpose data processor, a general-purpose computer, a computer system, or a group of networked computers or computer systems configured to perform the steps of credit management methods described below. In some embodiments, the system 100 is built on a personal computer platform, such as a Wintel PC or a Mac computer. The personal computer may be a desktop or a notebook computer.

The system 100 includes a processor 110, read only memory (ROM) module 120, random access memory (RAM) module 130, network interface 140, a mass storage device 150, and a database 160. These components are coupled together by a bus 115. In the illustrated embodiment, the processor 110 is a microprocessor, and the mass storage device 150 is a magnetic disk drive. The mass storage device 150 and each of the memory modules 120 and 130 are connected to the processor 110 to allow the processor 110 to write data into and read data from these storage and memory devices. The network interface 140 couples the processor 110 to the network 190, for example, the Internet. The nature of the network 190 and of the devices that may be interposed between the system 100 and the network 190 determine the kind of network interface 140 used in the system 100. In some embodiments, for example, the network interface 140 is an Ethernet interface that connects the system 100 to a local area network, which, in turn, connects to the Internet.

The database 160 is used for organizing and storing data that may be needed or desired in performing the method steps described in this document. The database 160 may be a physically separate system coupled to the processor 110, as illustrated in FIG. 1. In one alternative embodiment, the processor 110 and the mass storage device 150 are configured to perform the functions of the database 160.

The processor 110 reads and executes program code instructions stored in the ROM module 120. Under control of the program code, the processor 110 configures the system 100 to perform the steps of the methods described below. In addition to the ROM module 120, the program code instructions may be embodied in machine-readable storage media, such as hard drives, floppy diskettes, CD-ROMs, DVDs, and similar devices. The program code can also be transmitted over a transmission medium, for example, over electrical wiring or cabling, through optical fiber, wirelessly, or by any other form of physical transmission. The transmission can take place over a dedicated link between telecommunication devices, or through a wide- or local-area network, such as the Internet, an intranet, extranet, or any other kind of public or private network. In one embodiment, the program code is downloaded to the system 100 through the network interface 140.

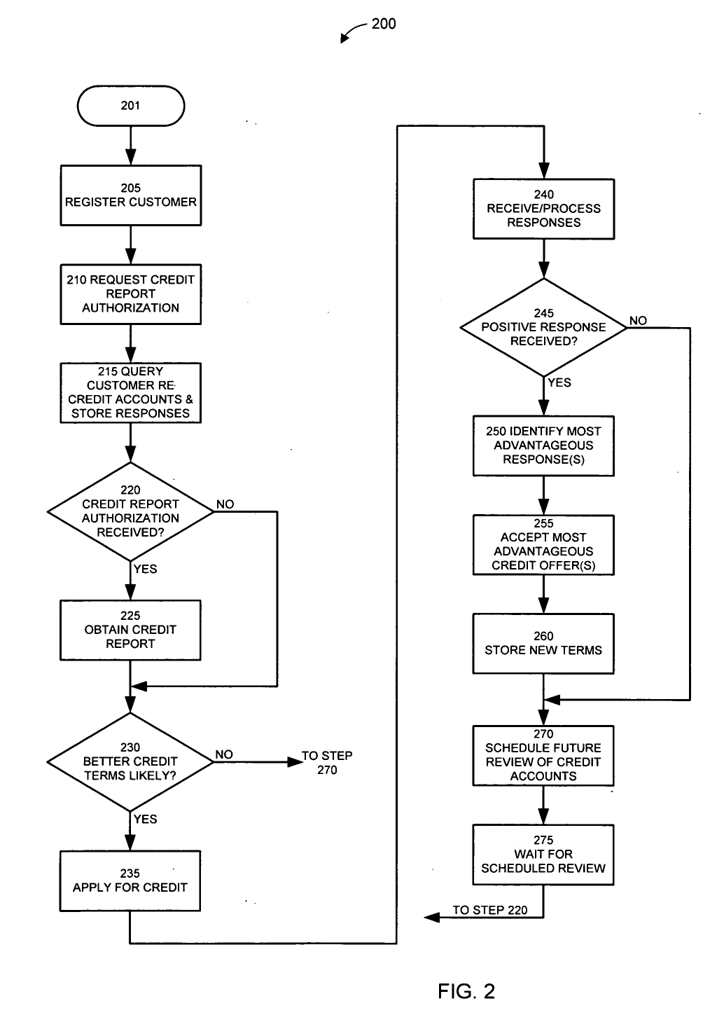

FIG. 2 is a process flow diagram illustrating selected steps and decision blocks of a process 200 for managing credit. The process 200 may be performed, in whole or in part, by the system 100 of FIG. 1, for example. The process 200 may also be performed by various other systems. Although the process steps and decisions are described serially, certain steps and decisions may be performed by separate elements in conjunction or in parallel, asynchronously or synchronously, in a pipelined manner, or otherwise. There is no particular requirement that the steps and decisions be performed in the same order in which this description lists them, except where a specific order is inherently required, explicitly indicated, or is otherwise made clear from the context. Furthermore, not every illustrated step and decision block may be required in every embodiment in accordance with the invention, while some steps and decision blocks that have not been specifically illustrated, may be desirable or necessary in some embodiments in accordance with the invention.

At flow point 201, the system 100 is properly configured and ready to perform the steps of the process 200. In step 205, the system registers a customer. The customer may be at one of the customer computers 180 connected to the system 100 via the network 190, as is illustrated in FIG. 1. Registration entails, for example, obtaining the customer's name, postal address, email address, telephone number, and financial profile information. The financial profile information may include the customer's income sources and their associated amounts, and various financial obligations, such as rent payments. Legally mandated or desirable disclosures, disclaimers, and terms of the agreement between the operator of the system 100 and the customer may also be presented to the customer at the time of registration. The agreement between the customer and the operator of the system 100 may include a provision authorizing the operator of the system 100 to apply for credit and accept credit offers on behalf of the client. The disclosures, disclaimers, and contract terms may vary depending on the location of the customer, in order to tailor these documents to the requirements of the customer's country, state, or another jurisdiction. The responses received from the customer and records indicating which documents have been provided to the customer are stored in the database 160.

In step 210, the system 100 requests the customer to provide authorization for periodically obtaining the customer's credit report from one or more credit reporting agencies, and stores in the database 160 the authorization or refusal received from the customer in response to the request.

In step 215, the system 100 queries the customer regarding various outstanding credit accounts, including credit lines, credit cards, and installment sale agreements, and stores the customer's responses in the database 160. The customer may be queried, for example, regarding the following information items:
Existing accounts;
Institution where each account is maintained;
Credit balance of each account;
Credit limit of each account;
Interest rate of each account;
Other terms of each account; and
User name and password needed for accessing each account electronically, i.e., on line.

In decision block 220, the system 100 determines whether the customer has provided authorization to obtain the customer's credit report in response to the request of the step 210. If the customer has provided such authorization, a credit report is obtained in step 225; otherwise, the step 225 is bypassed. The credit report may be obtained in electronic format over the communication network 190. In one embodiment, multiple credit reports are obtained from several credit reporting agencies, in order to improve accuracy of the financial information regarding the customer. Information from the credit report or reports is also stored in the database 160.

In decision block 230, the system 100 uses data derived from the customer's profile and credit reports (and possibly from other sources) to determine whether it is likely that other financial institutions would offer to the customer financial (credit) terms better than those the customer is currently being subjected to by the institutions where the customer maintains credit accounts. In some embodiments, the determination made in the decision block 230 may be based on the comparison between the respective costs based on the interest rates applicable to the specific balance or balances carried by the customer. In some embodiments, the costs considered also include fees in addition to the interest charged by the institutions, such as annual maintenance fees, over the limit fees, and late fees. The late fees may be appropriately discounted by the likelihood of the customer incurring such fees. Information regarding the likelihood of the customer making late payments may be obtained directly from the customer, for example, during the initial registration step, or at a later point. The likelihood of late fees may be obtained from the customer's history available from the credit reports and credit account statements obtained by the system 100.

In some embodiments, the financial terms considered in the decision block 230 include the length of time remaining until expiration of below market rate (e.g., zero or other teaser rate) financing available to the customer. Thus, if only a short period (e.g., one month or less) remains until expiration of a zero rate period with a current source of the customer's credit, the system 100 may determine that a zero rate or even a higher rate, but for a longer term, potentially available to the customer from another institution would be preferable. The rate from the other institution would then constitute “better terms,” despite the fact that it is the same as or higher than the rate that the customer is currently enjoying.

In some embodiments, the system 100 considers rewards coupled to the credit accounts in determining the financial terms. Value may be assigned to the rewards based on economic calculations generally acceptable when accounting for such rewards. Thus, points, miles, and similar reward measures tied to credit card usage may be translated into currency and subtracted from the credit costs. The reward amounts may be computed based on the customer's estimate, obtained, for example, during registration or at another time. The reward estimates may also be based on the customer's account usage history, obtained, for example, from the customer's credit reports, account statements, or previous experience with the customer. In some embodiments, the account usage history is obtained from or supplemented by information available to the system 100 on line from servers of financial institutions associated with the customer's current accounts. For example, the system 100 may use the network 190 to log onto the server maintaining the customer's account or accounts. The system 100 may then obtain the customer's usage history (amounts charged, for example) from the server. If some of the information is presented in graphic format, the system 100 may employ a text recognition application to extract the usage information and other data from the graphics presented by the server.

When the system 100 logs onto the customer's account, it may also determine the actual interest rate charged to the customer, as well as other fees. If the interest rate information is not readily available, the system 100 may infer it from the changes in balances, and payments and charges made by the customer. The system 100 may similarly be able to determine late payments made by the customer. Recall that a late payment may cause an immediate increase of the interest rates charged not only in the particular account in which the late payment is made, but also in other accounts. Thus, the system 100 may be able to predict such increases across the customer's credit portfolio. In response to such prediction, the decision block 230 may result in a positive determination even where the current rate paid by the customer is a teaser rate, because the rate will soon increase due to the late payment.

If the decision block 230 results in a determination that it is unlikely that improved financial terms would be offered to the customer, process flow advances to step 270. The determination in the block 230 may be based on the customer's credit score, such as Fair, Isaac & Co. (FICO) score, obtained from the customer's credit report. For example, the database 160 may store a table of credit scores and interest rates for which the customers of the system 100 with such scores may qualify. If the customer's credit score indicates that the customer will not qualify for an interest rate lower than that the customer is currently paying, the decision box 230 results in a negative determination, and the process flow advances to the step 270.

Furthermore, the system 100 may receive directly from the customer information regarding offers extended to the customer. For example, the customer may be able to transmit to the system 100 scanned copies of below market rate credit offers received by the customer via mail. Such offers may also be considered in making the determination in the decision block 230.

In the step 270, the system 100 schedules a future review of financial circumstances of the customer. In some embodiments, the review is scheduled approximately one typical billing cycle later, for example, in one month. In some embodiments, the review is scheduled in accordance with the customer's preference obtained at the time of registration, or at another time. Other criteria may also be used in scheduling the future review.

If the decision box 230 results in a determination that an improvement in financial terms offered to the customer is likely, process flow proceeds to step 235, where application for credit is made in the customer's name with one or more financial institutions that are likely to offer improved financial terms. In the illustrated embodiment, the application is made automatically, on line. In some alternative embodiments, application forms are downloaded from web sites of the financial institution, filled out and printed by the system 100, and marked for outgoing mail. (Certain steps of the process 200, including the mailing step, may be performed by human staff.)

The customer's contact information indicated on the credit application(s) may be email address, telephone number, facsimile number, and postal address associated with the operator of the system 100. Thus, responses to the credit applications may be received directly by the system 100, and then processed, as shown in step 240. For example, an email response may be parsed and processed to interpret the response. Conventional mail may be scanned into the system 100 and initially processed by character recognition software executing on the processor 110, to obtain a text file. The text file may then be parsed and processed as in the case of an email response.

From the step 240, process flow proceeds to decision block 245, to determine whether at least one positive response to the application(s) made in the step 235 has been received. A positive response is an offer of credit with improved financial terms. If no positive responses have been received, process flow advances to the step 270, scheduling a future review of financial circumstances of the customer, as has already been described. Otherwise, the most advantageous of the responses is identified in step 250. Note that the system 100 may wait for a period of time after receiving one response and before proceeding to the step 250, in order to allow additional responses to be received.

If a single positive response has been received, it is identified as the most advantageous response in the step 250. If multiple positive responses have been received, the responses may be rated in accordance with the same criteria as used to compare financial terms in the decision block 230. This, however, need not be interpreted as a requirement of the invention; other criteria may be used in the step 250 instead of or in addition to the criteria used in the decision block 230.

In some embodiments, several advantageous offers are identified in the step 250.

In step 255, the system 100 causes the most advantageous credit offer (or offers) to be accepted on behalf of the customer, and the customer's credit balance or balances to be transferred from existing account or accounts to the new account(s). This may be done electronically, on line, or by printing out forms and checks and mailing them to appropriate financial institutions.

From the step 255 process flow proceeds to step 260, storing in the database 160 terms of the newly-accepted offer(s), including expiration time of any teaser rate period that may be associated with the offers. This information may be used in the scheduling step 270, to which the process flow advances after the step 260. For example, a future review may be scheduled a sufficient time in advance of the expiration of the current teaser rate period, to have time to apply for credit with another financial institution and roll the credit balance over to the other financial institution before the current teaser rate expires.

It should be noted that a future review time may be scheduled before rolling over a credit balance becomes necessary. Consider, for example, a case when the customer has multiple market-rate credit accounts, or a single, relatively large credit balance. If only a single teaser rate offer is available to the customer (as determined in the decision block 245), but the offered credit line is insufficient for rolling over the outstanding balance or balances, the system 100 may transfer only a portion of the outstanding credit to the new account with the teaser rate. In order to attempt to obtain improved financial terms for the remaining balances that are subject to the market rate of the current account(s), the system 100 may schedule a future review in the step 270 before it becomes necessary to transfer the credit balance from the new account.

For example, if the new teaser rate period is three months, the system 100 may record this fact in the database 160. The system 100 may then schedule a future review for one month later, in order to attempt to transfer the remaining balance, which still accrues market interest rate. Whether or not the system 100 successfully transfers the remaining balance one month later, it may schedule a second review one month after the first review (i.e., two months after the partial balance transfer). The second review may be desirable to attempt to roll over the balance originally transferred to the new account, because the teaser rate will expire two months after the first scheduled review (i.e., three months after the partial balance transfer).

From the step 270, process flow proceeds to step 275, to wait for the next scheduled review. When the time of the next scheduled review comes, process flow returns to the decision block 220, and proceeds from there as has been described above.

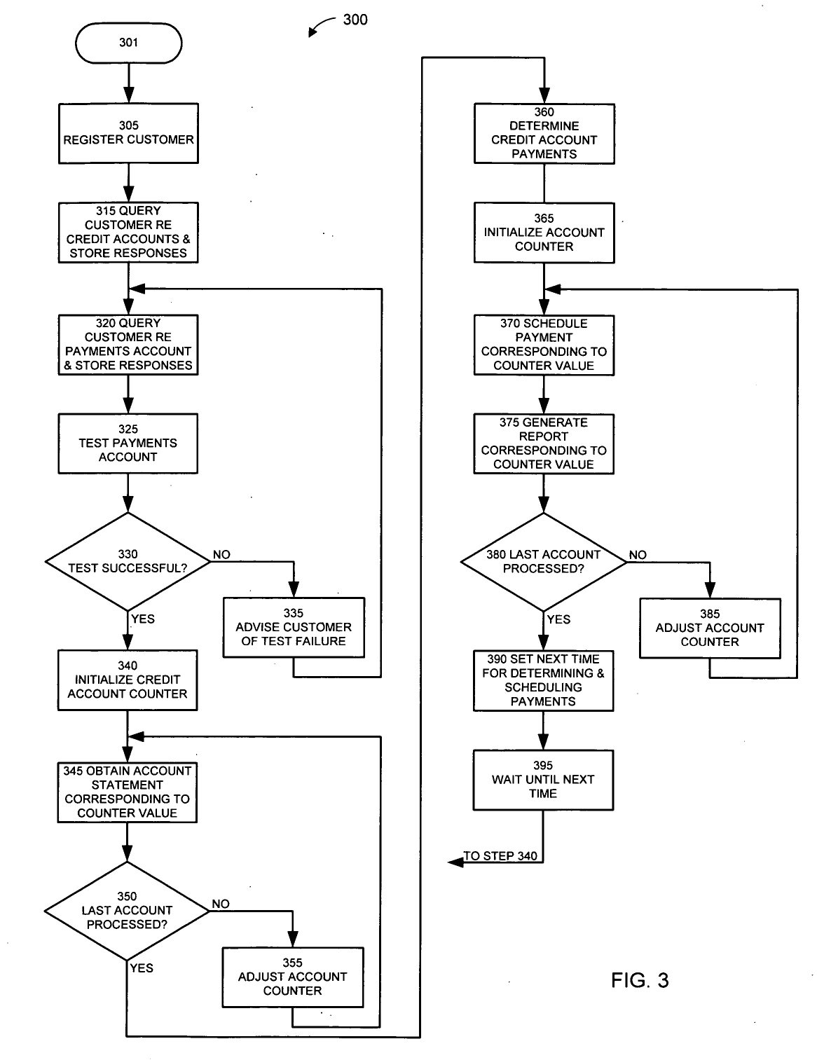

In another embodiment, the system 100 automatically pays the customer's credit card and other credit account bills. FIG. 3 is a process flow diagram illustrating selected steps and decision blocks of a process 300 for scheduling payments and determining payment amounts for the customer's credit account bills. The process 300 may be performed, in whole or in part, by the system 100 of FIG. 1, for example. The process 300 may also be performed by various other systems. Although the process steps and decisions are described serially, certain steps and decisions may be performed by separate elements in conjunction or in parallel, asynchronously or synchronously, in a pipelined manner, or otherwise. There is no particular requirement that the steps and decisions be performed in the same order in which this description lists them, except where a specific order is inherently required, explicitly indicated, or is otherwise made clear from the context. Furthermore, not every illustrated step and decision block may be required in every embodiment in accordance with the invention, while some steps and decision blocks that have not been specifically illustrated, may be desirable or necessary in some embodiments in accordance with the invention.

At flow point 301, the system 100 is properly configured and ready to perform the steps of the process 300. In step 305, which is similar to the step 205 of the process 200, the system 100 registers a customer. (This step may be omitted if the customer has already undergone registration as part of the process 200.) The customer may be at one of the customer computers 180 connected to the system 100 via the network 190, as is illustrated in FIG. 1. Registration entails, for example, obtaining the customer's name, postal address, email address, and telephone number. The system 100 may also ask the customer to provide account payment preferences, e.g., minimum payments or an amount in excess of the minimum payments. Legally mandated or desirable disclosures, disclaimers, and terms of the agreement between the operator of the system 100 and the customer may also be presented to the customer at the time of registration. The disclosures, disclaimers, and contract terms may vary depending on the location of the customer, in order to tailor these documents to the requirements of the customer's country, state, or another jurisdiction. The responses received from the customer and records of the documents provided to the customer are stored in the database 160.

In step 315, which is similar to the step 215 of the process 200, the system 100 queries the customer regarding various open credit accounts, including bank credit lines, credit cards, and installment sales agreements, and stores the customer's responses in the database 160. The customer may be queried, for example, regarding the following information items:
Existing accounts;
Institution where each account is maintained;
Credit balance of each account;
Credit limit of each account;
Interest rate of each account;
Other terms of each account; and
User name and password needed for accessing each account electronically, i.e., on line.

In step 320, the system queries the customer regarding an account from which electronic payments may be made, and stores the customer's responses in the database 160. Electronic payment services are available from a variety of sources, such as Intuit, American Express, and others. In the step 320, the customer may be queried, for example, regarding the institution that provides the electronic payment services to the customer, and the customer's user name and password needed for accessing the electronic payment services account. As part of this step, the customer is asked to consent to the use of the electronic payment services account by the system 100 on behalf of the customer. If the customer does not provide such consent, process flow is terminated. (This is not shown in FIG. 3.) Customer's responses are stored in the database 160.

In step 325, the system 100 logs onto the electronic payment services account and tests the account by making a small payment to a known account. The payment may be made, for example, into one of the customer's credit accounts, or to an account of the operator of the system 100, to cover the customer's fee for using the system 100 and its associated services. Making this payment tests for errors the information provided by the customer. The system 100 then logs off the account. If the payment is not made for some reason, as determined in decision block 330, the customer is advised of the problem in step 335, and process flow then returns to the step 320. The customer may be advised of the problem by email, for example.

If the payment is properly made, process flow continues to step 340, initializing a credit account counter. As will be seen, the counter is used to step through the customer's credit accounts.

In step 345, the system 100 logs onto the credit account corresponding to the current value of the account counter. After logging onto the account, the system 100 obtains the latest statement of the account, including the minimum amount due, and the date on which the amount is due. The system 100 may also obtain or determine the interest rate applicable to the outstanding balance of the account, and other charges, as has been described with respect to the process 200. This information is stored in the database 160.

In decision block 350, the system 100 determines whether the last account has been processed in the step 345. If the last account has not been processed, the account counter is adjusted to point to the next credit account. This is done in step 355. If the customer's credit accounts are numbered sequentially from 1 to N in increments of 1, for example, the account counter is incremented. Process flow then returns to the step 345.

After the last account has been processed in the step 345, process flow advances to step 360 to determine payments to be made on the customer's accounts. If the customer instructed the system 100 to make only minimum payments during registration (or at a later time), minimum payments are identified for the accounts. If some amount over the minimum payments should be paid, the amount is assigned to one or more of the credit accounts. For example, the additional amount may be assigned to the credit account with the highest interest rate, in order to minimize the total interest charges paid by the customer.

After the payments are determined, the account counter is initialized once again, in step 365. Payment date for the credit account corresponding to the current counter value is scheduled in step 370. The dates of the payments may be selected so that each scheduled payment is made on the last day on which it can be made timely. Other rules may also be used to schedule the payments.

Scheduling a payment may include setting an interrupt to trigger a payment process (e.g., process 400 described below) at the scheduled time.

After the payment is scheduled, a report of the credit account is generated for the customer, in step 375. The report may include, for example, various information that would ordinarily be expected to appear on a periodic statement regarding a credit account. In addition, the report includes one or more warnings, which may be highlighted in attention-drawing color, such as red, and conspicuously printed in large letters. The warnings may include, for example, the following information:
An estimate of the total interest charges that will be paid if payments continue to be made as in the past, for example, total interest charges during a repayment period resulting from making minimum payments;
An estimate of the length of the repayment period if payments continue to be made as in the past, for example, if the customer continues to make only the minimum payments; and
Estimates of the total interest charges and lengths of repayment periods if the customer makes some predetermined additional payment or payments on the account.

Other information may also be included in the report.

In computing the estimates of the total interest charges and the lengths of repayment periods, the system 100 may assume that the interest rate will remain constant, at least in the case of a market-based or fixed interest rate. The system 100 may also assume that a teaser interest rate will convert into a market rate at the expiration of the teaser rate period. The system 100 may further assume that the market interest rate will vary in accordance with some economic forecast.

In decision block 380, the system 100 determines whether the last of the credit accounts has been processed in the steps 370 and 375. If credit accounts remain to be processed, the account counter is adjusted (e.g., incremented) in step 385 to point to the next credit account, and process flow returns to the step 370. Otherwise, process flow advances to step 390, to set the next time for determining and scheduling payments.

Step 395, which follows the step 390, is a waiting step. Here, the process 300 waits for the next time for determining and scheduling payments, as set in the step 390. After the step 395, process flow returns to the step 340 and proceeds from there as has been described above.

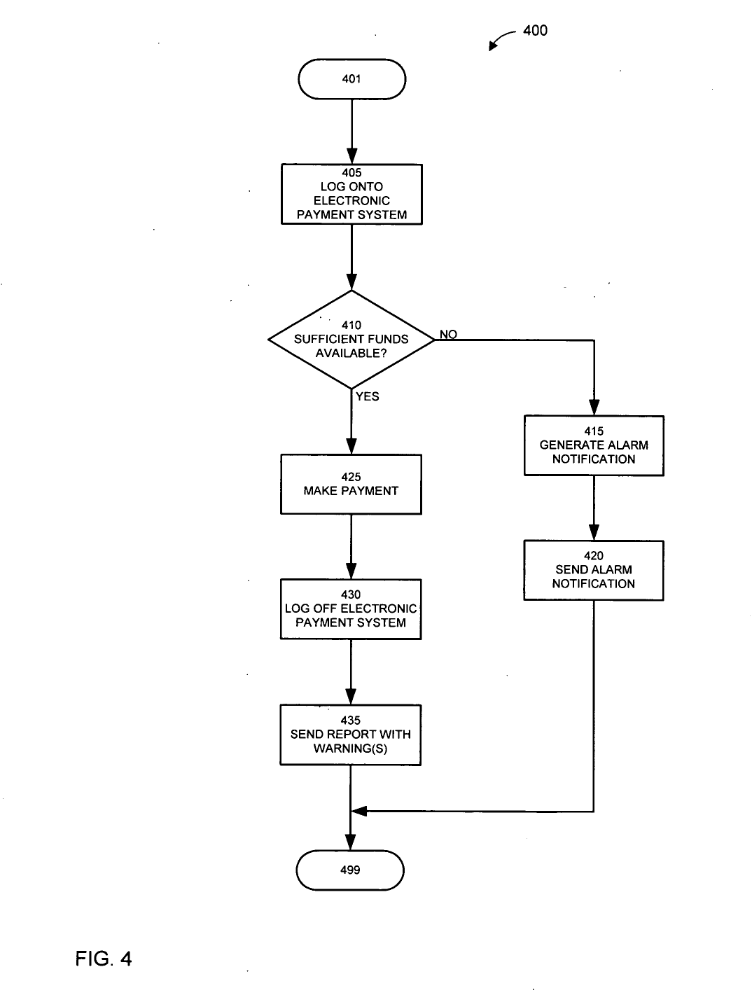

FIG. 4 is a process flow diagram illustrating selected steps and decision blocks of a process 400 for making payments that have been scheduled in the process 300. The process 400 may be performed, in whole or in part, by the system 100 of FIG. 1, for example. The process 400 may also be performed by various other systems. Although the process steps and decisions are described serially, certain steps and decisions may be performed by separate elements in conjunction or in parallel, asynchronously or synchronously, in a pipelined manner, or otherwise. There is no particular requirement that the steps and decisions be performed in the same order in which this description lists them, except where a specific order is inherently required, explicitly indicated, or is otherwise made clear from the context. Furthermore, not every illustrated step and decision block may be required in every embodiment in accordance with the invention, while some steps and decision blocks that have not been specifically illustrated, may be desirable or necessary in some embodiments in accordance with the invention.

At flow point 401, the system 100 is properly configured, and has been triggered to perform the steps of the process 400 for a particular credit account. In step 405, the system 100 logs onto the customer's electronic payment system.

In decision block 410, the system 100 determines whether sufficient flnds are available to make the scheduled payment. The system 100 may make this determination, for example, by parsing through a statement provided by the electronic payment system. If sufficient funds are unavailable, the system generates an alarm notification advising the customer that sufficient funds are unavailable, in step 415, and sends the notification to the customer, in step 420. For example, the alarm notification is sent via the network 190 using email or instant messaging. The process 400 then terminates at flow point 499.

If sufficient funds are available, process flow continues to step 425, in which the system 100 causes the scheduled payment to be made from the customer's electronic payment system.

In step 430, the system 100 logs off the electronic payment system.

In step 435, the system 100 sends to the customer the report corresponding to the credit account, which was generated in the step 375 of the process 300. The report may be sent, for example, via the network 190 using email.

After the report is sent, the process 400 terminates at the flow point 499.

This document describes in considerable detail the inventive apparatus, methods, and articles of manufacture for managing credit accounts. This was done for illustration purposes only. Neither the specific embodiments of the invention as a whole, nor those of its features limit the general principles underlying the invention. The specific features described herein may be used in some embodiments, but not in others, without departure from the spirit and scope of the invention as set forth herein. Various physical arrangements of components and various step sequences also fall within the intended scope of the invention. Many additional modifications are intended in the foregoing disclosure, and it will be appreciated by those of ordinary skill in the art that in some instances some features of the invention will be employed in the absence of a corresponding use of other features. The illustrative examples therefore do not define the metes and bounds of the invention and the legal protection afforded the invention, which function is carried out by the claims and their equivalents.

I claim:

1. A computer-implemented method of managing credit, the method comprising:
receiving from a customer authorization to act on behalf of the customer to make applications for new credit accounts and to accept credit offers directed to the customer;
applying for one or more new credit accounts on behalf of the customer;
in response to the step of applying, receiving approval of at least one new credit account of the customer with financial terms better than financial terms of at least one current credit account of the customer;
opening the at least one new credit account on behalf of the customer; and
transferring at least a portion of credit balance from the at least one current credit account to the at least one new credit account.

2. A method according to claim 1, wherein the steps of applying, receiving approval, opening, and transferring are performed over the Internet.

3. A method according to claim 2; further comprising:
receiving from the customer credit account information comprising data regarding the at least one current credit account.

4. A method according to claim 3, further comprising:
using the credit account information to obtain financial terms of the at least one current credit account; and
comparing financial terms of the at least one new credit account to the financial terms of the at least one current credit account before the step of opening.

5. A method according to claim 4, further comprising:
after the step of transferring, scheduling a next time for performing the step of applying.

6. A method according to claim 5, wherein the next time is one billing cycle of the at least one new credit account after the step of transferring is completed.

7. A method as in claim 5, wherein:
the credit account information comprises the customer's user name and password for logging onto web site providing information about the at least one current credit account; and
the step of using comprises:
logging onto the web site utilizing the customer's user name and password;
obtaining from the web site account statement of the at least one current credit account; and
determining the financial terms of the at least one current credit account from the statement.

8. A method as in claim 5, wherein the financial terms of the at least one current credit account comprise interest rate applied to the customer's balance of the at least one current credit account, and the step of comparing comprises performing a comparison of the interest rate applied to the customer's balance of the at least one current credit account and interest rate associated with the at least one new credit account.

9. A method according to claim 8, wherein the step of opening is performed in response to the step of comparing resulting in a determination that the interest rate applied to the customer's balance of the at least one current credit account is higher than the interest rate associated with the at least one new credit account.

10. A method according to claim 5, further comprising:
registering the customer over the Internet;
wherein:
the step of registering is performed before the steps of receiving authorization, applying, receiving approval, opening, and transferring; and
the step of registering comprises obtaining the customer's contact information and displaying to the customer at least one of disclaimer, disclosure, and agreement terms.

11. An article of manufacture comprising one or more memory devices storing computer code, wherein the code, when executed by a at least one processor coupled to the Internet, configures the processor to perform a method of managing credit, the method comprising:
receiving from a customer authorization to act on behalf of the customer to make applications for new credit accounts and to accept credit offers directed to the customer;
applying for one or more new credit accounts on behalf of the customer;
in response to the step of applying, receiving approval of at least one new credit account of the customer with financial terms better than financial terms of at least one current credit account of the customer;
opening the at least one new credit account on behalf of the customer; and
transferring at least a portion of credit balance from the at least one current credit account to the at least one new credit account.

12. A computer system comprising a memory device storing computer code, at least one processor coupled to the memory device so as to execute the computer code, and a network interface coupling the at least one processor to the Internet, wherein the computer code, when executed by the at least one processor, configures the at least one processor to perform steps of a method of managing credit, the method comprising:
receiving from a customer authorization to act on behalf of the customer to make applications for new credit accounts and to accept credit offers directed to the customer;
applying for one or more new credit accounts on behalf of the customer;
in response the step of applying, receiving approval of at least one new credit account of the customer with financial terms better than financial terms of at least one current credit account of the customer;
opening the at least one new credit account on behalf of the customer; and
transferring at least a portion of credit balance from the at least one current credit account to the at least one new credit account.

13. A computer system according to claim 12, wherein the computer code, when executed by the at least one processor, configures the at least one processor so that the steps of applying, receiving approval, opening, and transferring are performed over the Internet.

14. A computer system according to claim 13, wherein the computer code, when executed by the at least one processor, further configures the at least one processor to receive from the customer credit account information comprising data regarding the at least one current credit account.

15. A computer system according to claim 14, wherein the computer code, when executed by the at least one processor, further configures the at least one processor to perform steps comprising:
using the credit account information to obtain financial terms of the at least one current credit account; and
comparing financial terms of the at least one new credit account to the financial terms of the at least one current credit account before the step of opening.

16. A computer system according to claim 15, wherein the computer code, when executed by the at least one processor, further configures the at least one processor to
schedule a next time for performing the step of applying, after the step of transferring, wherein the next time is one billing cycle of the at least one new credit account after the time when the step of transferring is completed.

17. A computer system according to claim 15, wherein the computer code, when executed by the at least one processor, further configures the at least one processor to:
schedule a next time for performing the step of applying.

18. A computer system according to method claim 17, wherein:
the credit account information comprises the customer's user name and password for logging onto a web site providing information about the at least one current credit account; and
the computer code, when executed by the at least one processor, configures the at least one processor so that the at least one processor, in the course of performing the step of using,
logs onto the web site utilizing the customer's user name and password;
obtains from the web site account statement of the at least one current credit account; and
determines the financial terms of the at least one current credit account from the statement.

19. A computer system according to claim 17, wherein the financial terms of the at least one current credit account comprise interest rate applied to balance of the at least one current credit account, and the computer code, when executed by the at least one processor, configures the at least one processor so that the at least one processor performs a comparison of the interest rate applied to the balance of the at least one current credit account and interest rate associated with the at least one new credit account in the course of performing the step of comparing.

20. A computer system according to claim 19, wherein the computer code, when executed by the at least one processor, configures the at least one processor so that the at least one processor performs the step of opening in response to the step of comparing resulting in a determination that the interest rate applied to the balance of the at least one current credit account is higher than the interest rate associated with the at least one new credit account.

21. A computer system according to claim 17, wherein the computer code, when executed by the at least one processor, further configures the at least one processor so that, before performing the steps of receiving authorization, applying, receiving approval, opening, and transferring, the at least one processor obtains over the Internet the customer's contact information and displays to the customer over the Internet at least one of a disclaimer, a disclosure, and terms of agreement between the customer and operator of the computer system.

22. A computer implemented method of managing credit, the method comprising:
obtaining from a customer information regarding a plurality of credit accounts of the customer, the information regarding the credit accounts being sufficient to log onto web site of each credit account of the plurality of credit accounts and obtain a statement of the customer's credit account associated with said each web site;
obtaining from the customer information regarding an electronic payment account from which the customer can make electronic bill payments, the information regarding the electronic payment account being sufficient to log onto a web site of the electronic payment account and make bill payments from the electronic payment account;
logging onto the web site of said each credit account and obtain statement of said each credit account;
scheduling payment date and payment amount for said each credit account;
generate a report corresponding to said each credit account, wherein the report comprises an estimate of repayment period length computed assuming that only minimum payments are made to said each credit account;
causing a payment to be made to said each credit account from the electronic payment account on a date scheduled for the payment to said each credit account; and
sending the report corresponding to said each credit account to the customer.

23. A method according to claim 22, wherein the steps of obtaining information regarding the plurality of credit accounts, obtaining information regarding the electronic payment account, logging, causing, and sending are performed over the Internet.

24. A method according to claim 23, wherein the estimate is based on an assumption that interest rate will remain constant.

25. A method according to claim 23, wherein the estimate is based on an assumption that interest rate will vary in accordance with an economic forecast.

26. A method according to claim 23, wherein the report further comprises an estimate of total interest paid to said each account during the repayment period.

27. A method according to claim 23, wherein the report further comprises an estimate of a second repayment period length computed assuming that each payment made to said each credit account will include a predetermined amount in excess of minimum payment amount.

28. A method according to claim 23, wherein the report further comprises an estimate of total interest paid to said each account computed assuming that each payment made to said each credit account will include a predetermined amount in excess of minimum payment amount.
